(19) United States
(12) Patent Application Publication
(10) Pub. No.: US 2004/0245509 A1
(43) Pub. Date: Dec. 9, 2004

(54) Method for processing polymeric positive temperature coefficient conductive materials

(75) Inventors: Wen-Lung Liu, Taipei (TW); Kun-Huang Chang, Hsinchu (TW)

Correspondence Address: Ladas & Parry, 26 West 61st Street, New York, NY, 10023, US

(73) Assignee: INPAQ TECHNOLOGY CO., LTD.

(21) Appl. No.: 10/751,784

(22) Filed: Jan. 5, 2004

(30) Foreign Application Priority Data
Jun. 9, 2003 (TW) 092115528

(51) Int. Cl. H01B 1/00

(52) U.S. Cl. 252/500

(57) ABSTRACT

A method for processing polymeric positive temperature coefficient conductive material comprising the steps of placing a polymer material inside a plasma processor and then evacuating air therein to form a vacuum state, supplying a reactive gas to the plasma processor; and utilizing a radio frequency power generator for generating a plasma state inside the plasma processor, wherein the reactive gas is being excited to a high-level energy state, and the excited gas will attack the surface of the material to generate active sites. After that, the plasma-treated polymer material is exposed to air, and the radicals resided on the surface of the material will absorb moisture to form peroxide. The material is ground into powder before being placed inside the plasma processor, so that the contact surface can be increased to generate more radicals.

### BACKGROUND OF THE INVENTION

1. Field of the Invention

This invention generally relates to a method for processing polymeric positive temperature coefficient (PPTC) conductive materials, and more particularly relates to a method for processing plasma-treated polymer materials.

2. Description of the Prior Art

A PPTC conductive material compound is generally used to fabricate resettable overcurrent protection devices. The PPTC conductive material compound will be maintained in an electrically conductive state (at a low resistance) at a room temperature, because conductive particles (such as carbon black, graphite, metal particle, and metal fiber) or doped semiconductor material (such as metal oxide, metal carbide, and metal nitride) are evenly dispersed in the polymer material to form an electrically conductive chain. When the temperature rises to a particular point, such as the melting point of the polymer, the conductive chain will be broken due to an abrupt volume expansion, causing the polymer material to go into an isolative state (at a high resistance) so as to block the current to protect circuits or devices.

U.S. Pat. No. 5,190,697 teaches a fabrication method in which an organic peroxide having molecular formula 1 is heated to generate radicals so as to attack the branched hydrogen atom, and thereby the polyethylene radicals (P.) having molecular formula 2 are formed.

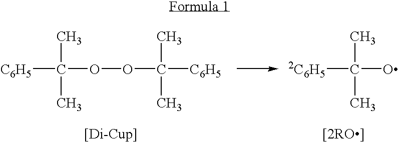

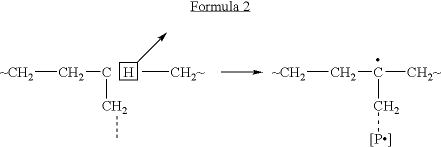

Consequentially, the polyethylene radicals will be integrated with the functional group on the surface of the carbon blacks, or will be self-linked to form a network structure. The problem with this method is that it is hard to control the reaction. In addition, the residual organic peroxide must be heated again and completely reacted at 200° C. to be eliminated so as to avoid the residual organic peroxide to affect the electric stability of devices.

U.S. Pat. Nos. 5,864,280, 5,880,668, and 6,059,997 mainly teach and disclose employing a graft reaction technique to produce an improved PPTC conductive polymer composition, wherein the polarity functional group is grafted on the molecule chain of the polyethylene. The polyethylene is a serial material of DuPont “Fusabond” containing maleic anhydride so that it is expensive and has high moisture absorption, and easily affects the lifetime and the reliability of the device. Therefore, a dehydrating process is important when the material is used, increasing the fabrication cost and complexity.

Moreover, U.S. Pat. Nos. 5,841,111, 5,886,324, 5,928,547, and European Patent Publication No. 0853322A1 use expensive and precise plasma equipment to improve the electric characteristic of devices; however, the prior art equipment merely reduces the contact resistance and increases the adhesion force between the electrode and the conductive material, but conductivity homogeneity in the conductive material, reliability, and thermal stability of the device cannot be improved.

Because of the foregoing disadvantages, a method for processing polymeric positive temperature coefficient (PPTC) conductive material having evenly distributed conductive particles is needed for reducing the contact resistance between the electrode and the conductive material, and for eliminating the moisture absorption of the conventional PPTC conductive material, so as to increase the lifetime and reliability.

### SUMMARY OF THE INVENTION

To remove the foregoing drawbacks caused by the conventional PPTC conductive polymer compound, the subject invention provides a method for processing a polymer material which is treated by plasma.

The main object of the subject invention is to evenly dispersed conductive particles in a conductive material, and to facilitate combination of polymer and carbon black by using an ordinary plasma system, so as to reduce the contact resistance between an electrode and a conductive material. Accordingly, the problems of the lifetime and the reliability affected by the moisture in the conductive material compound may be resolved.

According to the above object, the subject invention provides a method for processing polymeric positive temperature coefficient conductive material, comprising the steps of placing a polymer material inside a plasma processor and then evacuating air therein to form a vacuum state; supplying a reactive gas to the plasma processor; and utilizing a radio frequency power generator for generating a plasma state inside the plasma processor, wherein the reactive gas is excited to a high-level energy state, and the excited gas will attack the surface of the polymer material to generate active sites. Afterwards, the plasma-treated polymer material is exposed to air, and the radicals resided on the surface of the material will absorb moisture to form a peroxide. The polymer material is grounded to become powders before it is placed inside the plasma processor, so that the area of the contact surface can be increased to generate more radicals.

### BRIEF DESCRIPTION OF THE DRAWINGS

The foregoing aspects and many advantages of the subject invention will become more readily appreciated as the same becomes better understood by reference to the following detailed description, when taken in conjunction with the accompanying drawings, wherein:

FIG. 1 illustrates a rotary plasma processor for fabricating a plasma-treated polymer material according to the subject invention;

FIG. 2 illustrates a preferred embodiment of a method for fabricating a plasma-treated polymer material according to the subject invention;

FIG. 3 illustrates another preferred embodiment of a method for fabricating a plasma-treated polymer material according to the subject invention;

FIG. 4 illustrates an electric conductive substrate fabricated according to the methods of the subject invention; and

FIG. 5 illustrates a resistance-temperature chart showing variations between a device fabricated by using a plasma-pretreated polymer material and a device fabricated by using a conventional high density polyethylene material.

### DETAILED DESCRIPTION OF THE PREFERRED EMBODIMENT

A number of embodiments of the invention will now be described in greater detail. Nevertheless, it should be noted that the present invention can be practiced in a wide range of other embodiments in addition to those explicitly described, and the scope of the present invention is not limited to that specified in the claims.

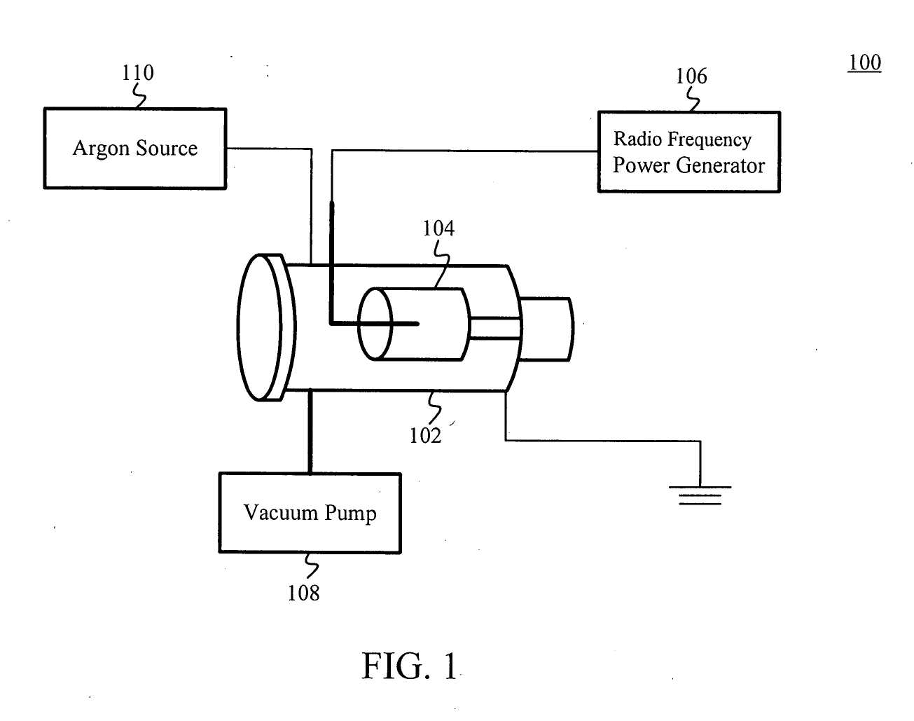

FIG. 1 illustrates a rotary plasma processor 100 for fabricating a plasma-pretreated polymer material according to the subject invention. The processor 100 comprises a plasma reactor 102 containing a rotatable chamber 104, and a radio frequency power generator 106 coupled to the rotatable chamber 104 for generating plasma. The processor 100 further comprises a vacuum pump 108 and an argon source 110 coupled to the plasma reactor 102 respectively for providing a vacuum state and an argon. A reactive gas can be selected from of group consisting of helium, nitrogen, hydrogen, and oxygen.

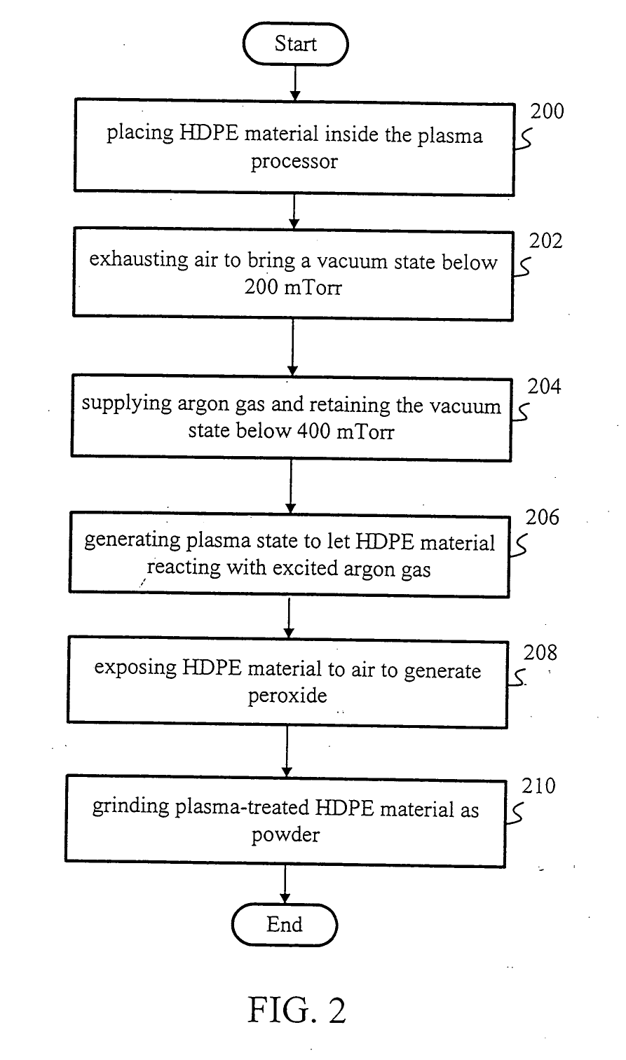

FIG. 2 shows a preferred embodiment of a method of the subject invention, in which polymer materials, such as HDPE (high density polyethylene) particles are placed inside the rotatable chamber 104 (step 200) of the rotary plasma processor 100. Consequentially, the vacuum pump 108 is actuated to keep the atmosphere inside the reactor below 200 m Torr (step 202), and then the argon gas is supplied to keep the atmosphere below 400 m Torr (step 204). The radio frequency power generator (106) is switched on to generate plasma, and a tuner of the radio frequency power generator (106) is adjusted to a preferred power of 40 w-80 w and a frequency of 13.52 MHz. The HDPE particles are ratated inside the rotatable chamber 104 so as to well mix with the argon to result in a uniform plasma reaction, and a preferred treatment period is around 1 to 10 minutes (step 206). In step 208, the treated HDPE particles are taken out and exposed to air for around 1 to 30 minutes. The radicals resided at the surface of the HDPE particles will absorb moisture to become a peroxide. Lastly, the treated HDPE particles are ground into powder (step 210) having a diameter less than 1 mm. The common approach for grinding HDPE particles has to use a liquid nitrogen to decrease the heat caused during grinding, because a high temperature will render the HDPE material soft and sticky and consequently the HDPE material is hard to grind.

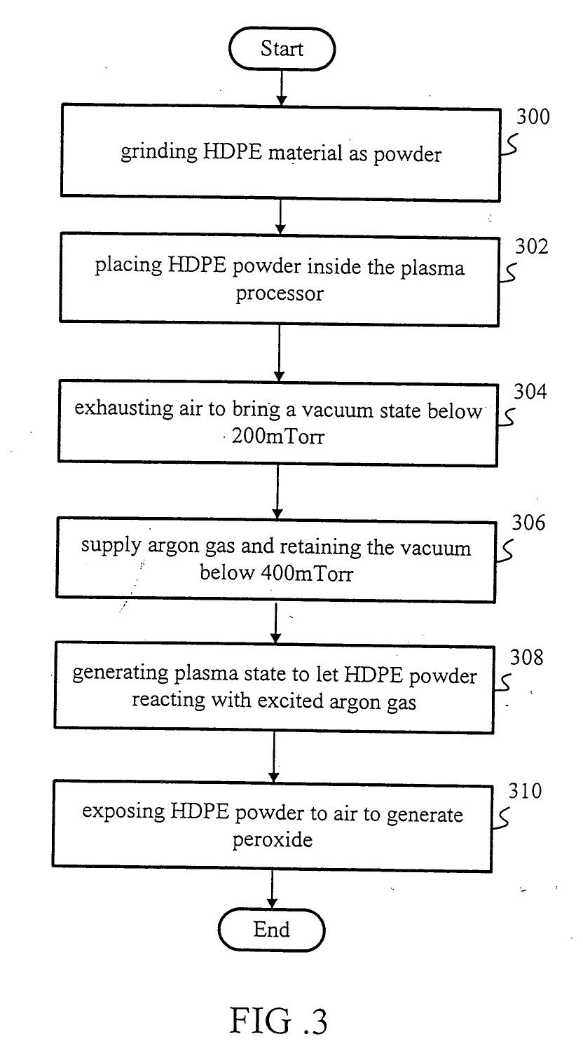

FIG. 3 is another preferred embodiment of a method for fabricating plasma-pretreated polymer material according to the subject invention. In step 300, the HDPE particles are ground into powder having a diameter equal to or greater than 1 mm. In step 302, the HDPE powder is placed inside the rotary plasma processor (104). In step 304, the vacuum pump (108) is switched on for evacuating the chamber (104) until the atmosphere inside the chamber is below 200 mTorr. In step 306, the argon gas is supplied to retain the atmosphere below 400 mTorr. In step 308, the radio frequency power generator is switched on to generate (106) plasma, and the tuner of the radio frequency power generator (106) is adjusted to a preferred power of 40 w-80 w and frequency of 13.52 MHz, in which the reactive gas can be selected from a group consisting of helium, nitrogen, hydrogen, and oxygen. The HDPE material inside the rotatable chamber (104) is rotated so as to well mix with argon to result in uniform plasma reaction, and the length of a preferred treatment period is around 1 to 10 minutes. In step 310, the treated HDPE particles are taken out and exposed to air for around 1 to 30 minutes, and thus the radicals resided at the surface of the HDPE particles will absorb moisture to become a peroxide. In this method, the area of the contact surface may be increased to provide more radicals to achieve a better effect.

The plasma-treated HDPE material according to the above embodiments has the following molecular formula:

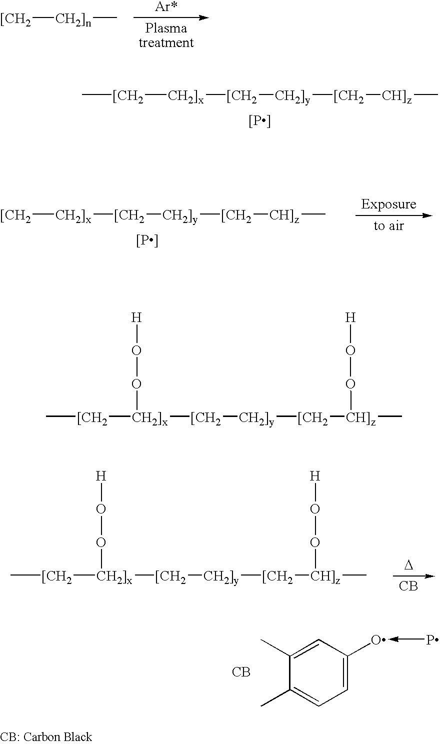

The materials listed in Table 1, including the plasma-treated HDPE powders, carbon black, facilitator, and anti-oxidant, are mixed in c. w. Brabender Mixer, and these materials will be completely melted after 3-5 minutes at 190° C., 10 rpm. Consequently, the temperature will rise due to the reaction and the friction. The temperature and rotation rate are set at 190° C. and 60 rpm respectively, and then the mixing operation will be done after 10 minutes.

TABLE 1

| | Plasma-untreated | Plasma-treated |
|---|---|---|
| Process | Weight (g) | Weight (g) |
| HDPE | 112.82 | 116.39 |
| Carbon black | 127.18 | 123.61 |
| Anti-oxidant | 2.40 | 2.40 |
| Processing | 2.26 | 2.33 |
| aid Agent | | |

After the mixed materials are cooled down, a pulverizer is used to pulverize the mixed materials into shattered pieces. The mixed materials will be produced as sheet-shape having thickness 0.28-0.30 mm, and be cut as a plate of 10 cm*10 cm by an extruder equipped with a T-die. A hot press is used to produce an electrically conductive substrate in way of pressurization at temperatures of 160° C.-180° C., where metal foil having average surface roughness (Ra) of approximately 1.2-1.8 microns placed on the top surface and bottom surface of the substrate respectively. The temperature of the electrically conductive substrate will continue to cool down when being pressed. The substrate will be moved out so that its temperature cools down to the room temperature when the surface is completely hardened. The substrate is irradiated by γ-ray from a Co-60 irradiation source to complete the irradiation cross-linking process. The substrate is cut to form chips of 6.35 mm*5.08 mm, so as to directly measure their resistance under room temperature and the resistance variation curve when the temperature is changed.

TABLE 2
Initial Resistance

| No./Process | Plasma-untreated (mΩ) | Plasma-treated (mΩ) |
|---|---|---|
| 1 | 43.86 | 41.82 |
| 2 | 42.10 | 32.61 |
| 3 | 30.65 | 35.98 |
| 4 | 43.38 | 42.40 |
| 5 | 39.81 | 29.01 |
| 6 | 37.17 | 37.91 |
| 7 | 39.21 | 28.88 |
| 8 | 41.38 | 37.91 |
| 9 | 37.00 | 28.88 |
| 10 | 27.79 | 26.79 |
| 11 | 42.00 | 38.05 |
| 12 | 32.47 | 38.99 |
| 13 | 31.81 | 36.13 |
| 14 | 44.04 | 42.18 |
| 15 | 46.75 | 38.10 |
| 16 | 30.25 | 38.26 |
| 17 | 42.02 | 38.23 |
| 18 | 27.59 | 31.94 |
| 19 | 44.81 | 40.75 |
| 20 | 42.12 | 30.76 |
| Average value | 38.31 | 35.78 |
| Standard | 6.07 | 4.92 |
| variation | | |

The HDPE materials shown in Table 2 (plasma-treated and untreated) are processed to form two kinds of electrically conductive substrate according to the embodiment of the present invention. The substrate and a foil are pressed together and then cut to be specimens of 6.35 mm*5.08 mm (0.25 inch*0.20 inch). The initial resistance of the specimen is measured at room temperature (23±2° C.). After analysis and comparison, it is found that the average resistance and the standard variation of the specimen using plasma-treated formula are lower than those of the specimen using plasma-untreated formula. Table 3 and Table 4 show results of the cycle life test and the trip endurance test of the specimen. The electrical properties, thermal stability, and contact resistance may be obtained during the cycle life test and the trip endurance test.

The present invention discloses another method for fabricating electrically conductive substrate, which is manufactured by W & P twin screw extruder compounding system, model no. ZSK-30. A conductive material comprising a 51.3% plasma-treated polymer material by weight and 48.7% carbon black by weight is fed into the W & P twin screw extruder compounding system by a gravimetric feeder.

The W & P twin screw extruder compounding system is operated under following conditions: melting temperature 220˜230° C., screw rotation rate 170 rpm, screw configured as co-rotating, melting pressure 2000 psi, and linear speed 1-2 M/min.

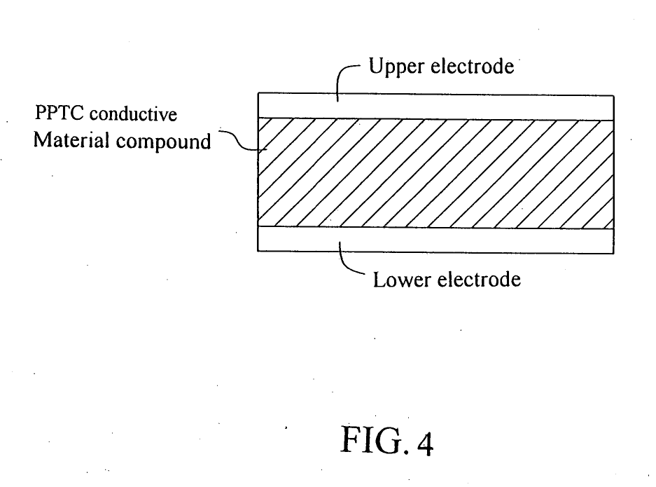

The thickness of the substrate produced by the W & P twin screw extruder compounding system is controlled to be in the range of 0.28 mm˜0.30 mm, and then the foils are pressed onto the surfaces of the substrate by a hot press. After the previous processing, the substrate is formed as shown in FIG. 4.

TABLE 3
Cycle Life Test

| | | | | | Resistance |
|---|---|---|---|---|---|
| | | Resistance | Resistance | Resistance | after a |
| | Initial | after | after two | after ten | hundred |
| Specimen | Resistance | one cycle | cycles | cycles | cycles |
| no. | (Ohms) | (Ohms) | (Ohms) | (Ohms) | (Ohms) |
| 1 | 0.1312 | 0.1173 | 0.1014 | 0.0859 | 0.1448 |
| 2 | 0.1383 | 0.1213 | 0.1067 | 0.0999 | 0.1306 |
| 3 | 0.1467 | 0.1277 | 0.1123 | 0.0943 | 0.1387 |
| 4 | 0.1228 | 0.1082 | 0.0937 | 0.0791 | 0.1407 |
| 5 | 0.1261 | 0.1108 | 0.0962 | 0.0803 | 0.1132 |
| 6 | 0.1487 | 0.1296 | 0.1139 | 0.0961 | 0.1553 |
| 7 | 0.1157 | 0.1043 | 0.0905 | 0.0761 | 0.0927 |
| 8 | 0.1358 | 0.1209 | 0.1061 | 0.0885 | 0.1194 |
| 9 | 0.1435 | 0.1276 | 0.1125 | 0.0944 | 0.1121 |
| 10 | 0.1299 | 0.1161 | 0.1017 | 0.0851 | 0.1243 |

The cycle life test and trip endurance test can be employed to test electric properties, thermal stability, and contact resistance of the specimen produced according to the foregoing method.

The results of cycle life test are shown in Table 3, in which 10 seconds of 40 A current is passed through the specimen and then the current or voltage supply are stopped for 120 seconds of resetting time as one life cycle. After 100 times of the cycle life test, the variation with respect to the average resistance value is −5.00%.

TABLE 4
Trip Endurance Test

| | Initial | | After 24 | After 48 | After 168 |
|---|---|---|---|---|---|
| Specimen | Resistance | After 1 hour | hours | hours | hours |
| No. | (Ohms) | (Ohms) | (Ohms) | (Ohms) | (Ohms) |
| 1 | 0.1396 | 0.1073 | 0.1044 | 0.1069 | 0.1297 |
| 2 | 0.1391 | 0.1074 | 0.1031 | 0.1022 | 0.1193 |
| 3 | 0.1287 | 0.0972 | 0.1023 | 0.1028 | 0.1103 |
| 4 | 0.1152 | 0.0906 | 0.0979 | 0.0981 | 0.1057 |
| 5 | 0.1241 | 0.0956 | 0.1009 | 0.1008 | 0.1081 |
| 6 | 0.1433 | 0.1084 | 0.1163 | 0.1136 | 0.1194 |
| 7 | 0.1124 | 0.0909 | 0.0997 | 0.0976 | 0.1027 |
| 8 | 0.1314 | 0.1012 | 0.1081 | 0.1075 | 0.1134 |
| 9 | 0.1424 | 0.1091 | 0.1174 | 0.0944 | 0.1232 |
| 10 | 0.1289 | 0.0984 | 0.1029 | 0.1023 | 0.1065 |

The trip endurance test as shown in Table 4 is conducted at 40 A current that passes through the specimen for 15 seconds to cause the specimen to be in a tripped state, and a switch provides both sides of the specimen with 30 volts. The resistance of the specimen is measured after one hour, 24 hours, 48 hours, and 168 hours.

After 168 hours of the trip endurance test, the variation with respect to the average resistance value is −12.66%.

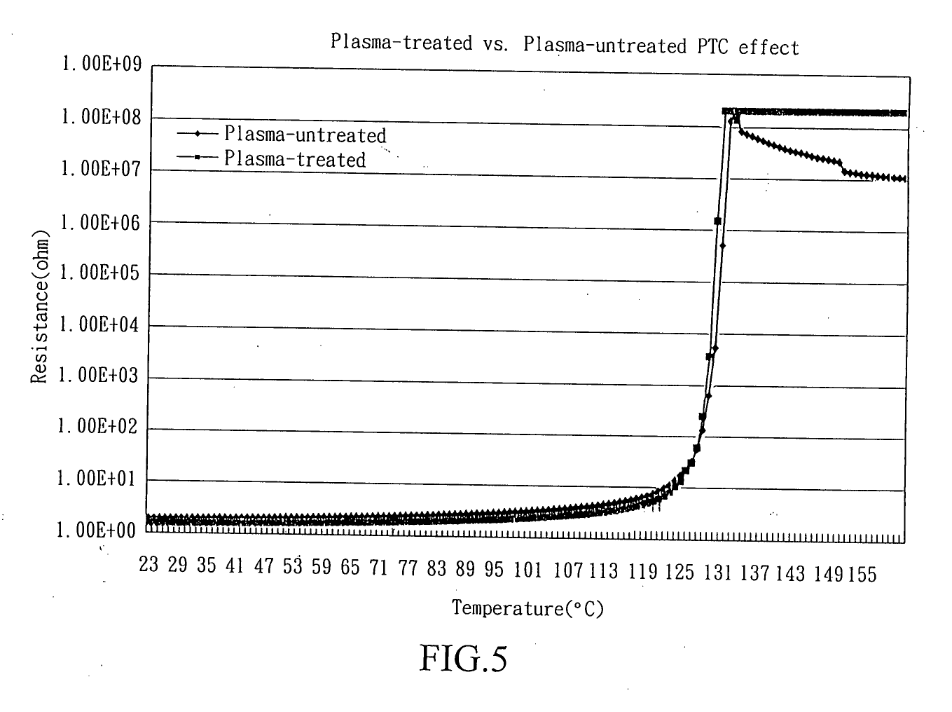

FIG. 5 illustrates a resistance-temperature chart with respect to the variations between the device fabricated by using a plasma-treated polymer material and the device fabricated by using a conventional high density of polyethylene material. A way to test the variations uses a program-controlled oven, a resistance tester, and a scanning system to raise the temperature from the room temperature (23±2° C.) to 160° C. at the heating rate 2° C./min, and then to sample at the sampling rate 1 time/1° C.

As shown in FIG. 5, the curve slope of the resistance of the plasma-treated PTC device is steeper than that of the plasma-untreated PTC device. Besides, the resistance of the plasma-treated PTC device may remain at the peak rather descend after the peak as the plasma-untreated PTC device, i.e. the negative temperature coefficient effect. Also, the initial resistance of the plasma-treated PTC device is lower than that of the plasma-untreated PTC device.

In accordance with the above, the subject invention uses ordinary plasma processing system to evenly distribute the conductive particles among conductive material, so as to reduce the contact resistance between the electrode and the conductive material, and to facilitate the combination of the polymer and the carbon black. Also, the problem of the device lifetime and the reliability affected by the moisture absorption of conductive material compound may be resolved.

Although specific embodiments have been illustrated and described, it will be obvious to those skilled in the art that various modifications may be made without departing from what is intended to be limited solely by the appended claims.

What is claimed is:

1. A method for processing a polymeric positive temperature coefficient conductive material, comprising the steps of:
placing the material inside a plasma processor, and then evacuating air in the processor to form a vacuum state;
supplying a reactive gas to the processor;
generating a plasma state in the processor to let the material react with the gas; and
exposing the plasma-treated polymer material to air, wherein the radicals resided on the surface of the material absorb moisture to form peroxides.

2. The method according to claim 1, wherein the gas is selected from the group consisting of argon, helium, nitrogen, hydrogen, and oxygen or a combination thereof.

3. The method according to claim 1, wherein the vacuum state is below 200 m Torr.

4. The method according to claim 1, wherein the vacuum state is retained below 400 m Torr when the gas is supplied to the processor.

5. The method according to claim 1, wherein the plasma state is generated by a radio frequency power generator.

6. The method according to claim 5, wherein the generator is adjusted to have a power of 40 w-80 w, a frequency 13.52 MHz, a duration of 1-60 minutes, wherein an optimal duration is 3-20 minutes.

7. The method according to claim 5, wherein the optimal duration is 5-10 minutes.

8. The method according to claim 1, further comprising the step of grinding the exposed polymer material into powder.

9. The method according to claim 8, wherein the powder has a diameter of small than 1 mm.

10. The method according to claim 1, wherein the material is ground into powder before being placed inside the processor.

11. The method according to claim 10, wherein the powder has a diameter of greater than 1 mm.
